(19) United States
(12) Patent Application Publication
(10) Pub. No.: US 2026/0054417 A1
(43) Pub. Date: Feb. 26, 2026

(54) CUTTING MACHINE FOR SINTERED STONES

(71) Applicant: Hui-Chuan LIAO, Oakland, CA (US)

(72) Inventor: Hui-Chuan LIAO, Oakland, CA (US)

(21) Appl. No.: 18/814,286

(22) Filed: Aug. 23, 2024

(51) Int. Cl. B28D 1/24; B28D 1/22

(52) U.S. Cl. CPC B28D 1/24; B28D 1/228

(57) ABSTRACT

A cutting machine for sintered stones has a track base, a cutting device, and two clamping devices. The track base has at least one connecting portion and an anti-slip strip mounted in the at least one connecting portion. The cutting device is connected to the track base and has a cutter and two measuring seats. The cutter has a cutting wheel. The measuring seats are movably disposed on the track base respectively at two sides of the cutter, and each measuring seat has a positioning arm. The positioning arm has a reference board with an external side face. An imaginary extension line of the external side face of the reference board of each measuring seat aligns with a cutting edge of the cutting wheel. The clamping devices are connected to the track base, and each clamping device has a clamping mount and a pressing rod.

### BACKGROUND OF THE INVENTION

### 1. Field of the Invention

The present invention relates to a cutting machine, and more particularly to a cutting machine for sintered stones that is convenient for measurement, safe to use, securely clamped, and accurate for cutting.

### 2. Description of Related Art

Building materials such as glass, tiles, and sintered stones often need to be cut into corresponding shapes and sizes according to users' needs. Among them, sintered stone is a high-hardness plate made of natural materials through vacuum extrusion and high-temperature sintering, and has characteristics of anti-wear, scratch resistance, high temperature resistance, and environmental protection, etc. Therefore, sintered stones are commonly used in the fields of construction, decoration, furniture, etc. Since the sintered stones are high-hardness slabs, the requirements for cutting accuracy and stability are higher than those of glass and tiles, so they cannot be used with ordinary cutting machines and need to be matched with a cutting machine for sintered stones.

A conventional cutting machine for sintered stones has a track base, a cutter, and multiple suckers. The track base is elongated. The cutter is movably disposed on the track base and has an operating shaft and a cutting wheel. The operating shaft is swingably disposed on the cutter and is located on one side of the track base. The cutting wheel is located below the cutter and is connected to the operating shaft. Then the cutting wheel can be moved relative to the track base by the operating shaft. The multiple suckers are connected to the track base and are located on the other side of the track base. When the conventional cutting machine for sintered stones is in use, the track base is disposed on a top of a processed sintered stone and is moved relative to the processed sintered stone according to a cutting location. After moved to the cutting location, the track base can be held securely on the processed sintered stone by the multiple suckers adsorbed to the top of the processed sintered stone. Then a user can hold and swing the operating shaft to move the cutting wheel toward the processed sintered stone, as the operating shaft moves, the cutting wheel abuts against the processed sintered stone. With the movement of the operating shaft relative to the track base, the cutting wheel forms a cutting line on the processed sintered stone, and the operation of the conventional cutting machine for sintered stones is completed.

The conventional cutting machine for sintered stones can provide a cutting effect to the processed sintered stone, however, when measuring the cutting position for the processed sintered stone, the user needs to extend fingers to the cutting wheel to measure the actual cutting location. Since the cutting wheel is located below the operating shaft, this is not only inconvenient to measure, but also often injuries the user's fingers due to the sharp edge of the cutting wheel, and raises safety concerns. Furthermore, although the conventional cutting machine can be easily assembled and disassembled on the processed sintered stone by the multiple suckers, after long-term use, the materials of the multiple suckers are easily affected by material changes, which affects the adsorption strength and stability of the multiple suckers to the processed sintered stone. Then the track base cannot be stably held on the processed sintered stone, and this will affect the accuracy of the subsequent cutting of the conventional cutting machine to the processed sintered stone. The conventional cutting machine for sintered stones has the above-mentioned problems and deficiencies and needs improvement.

The cutting machine for sintered stones in accordance with the present invention mitigates or obviates the aforementioned problems.

### SUMMARY OF THE INVENTION

The main objective of the present invention is to provide a cutting machine for sintered stones that is convenient for measurement, safe to use, securely clamped, and accurate for cutting.

The cutting machine for sintered stones in accordance with the present invention has a track base, a cutting device, and two clamping devices. The track base has at least one connecting portion and an anti-slip strip mounted in the at least one connecting portion. The cutting device is connected to the track base and has a cutter and two measuring seats. The cutter has a cutting wheel. The measuring seats are movably disposed on the track base respectively at two sides of the cutter, and each measuring seat has a positioning arm. The positioning arm has a reference board with an external side face. An imaginary extension line of the external side face of the reference board of each measuring seat aligns with a cutting edge of the cutting wheel. The clamping devices are connected to the track base, and each clamping device has a clamping mount and a pressing rod.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a cutting machine for sintered stones in accordance with the present invention;

FIG. 2 is an enlarged perspective view of the cutting machine for sintered stones in FIG. 1;

FIG. 3 is an enlarged top side view of the cutting machine for sintered stones in FIG. 1;

FIG. 4 is an exploded perspective view of the cutting machine for sintered stones in FIG. 1;

FIG. 5 is an enlarged and exploded perspective view of the cutting machine for sintered stones in FIG. 1;

FIG. 6 is an enlarged and cross-sectional side view of the cutting machine for sintered stones in FIG. 1;

FIG. 7 is another enlarged and cross-sectional side view of the cutting machine for sintered stones in FIG. 1;

FIG. 8 is an enlarged side view in partial section of the cutting machine for sintered stones in FIG. 1;

FIG. 9 is an operational perspective view of the cutting machine for sintered stones in FIG. 1, mounted on a processed sintered stone;

FIG. 10 is an enlarged and operational perspective view of the cutting machine for sintered stones in FIG. 9;

FIG. 11 is an enlarged and operational perspective view of a measuring seat of the cutting machine for sintered stones in FIG. 10;

FIG. 12 is an enlarged and operational perspective view of a cutting wheel of the cutting machine for sintered stones in FIG. 10;

FIG. 13 is an enlarged side view in partial section of the cutting machine for sintered stones in FIG. 10;

FIG. 14 is an enlarged, operational and cross-sectional side view of the cutting machine for sintered stones in FIG. 10;

FIG. 15 is an enlarged and operational top side view of the cutting machine for sintered stones in FIG. 10;

FIG. 15A is an enlarged and operational top side view of the cutting machine for sintered stones in FIG. 15;

FIG. 15B is another enlarged and operational top side view of the cutting machine for sintered stones in FIG. 15; and

FIG. 16 is an enlarged and operational top side view of the measuring seat of the cutting machine for sintered stones in FIG. 10.

### DETAILED DESCRIPTION OF THE PREFERRED EMBODIMENT

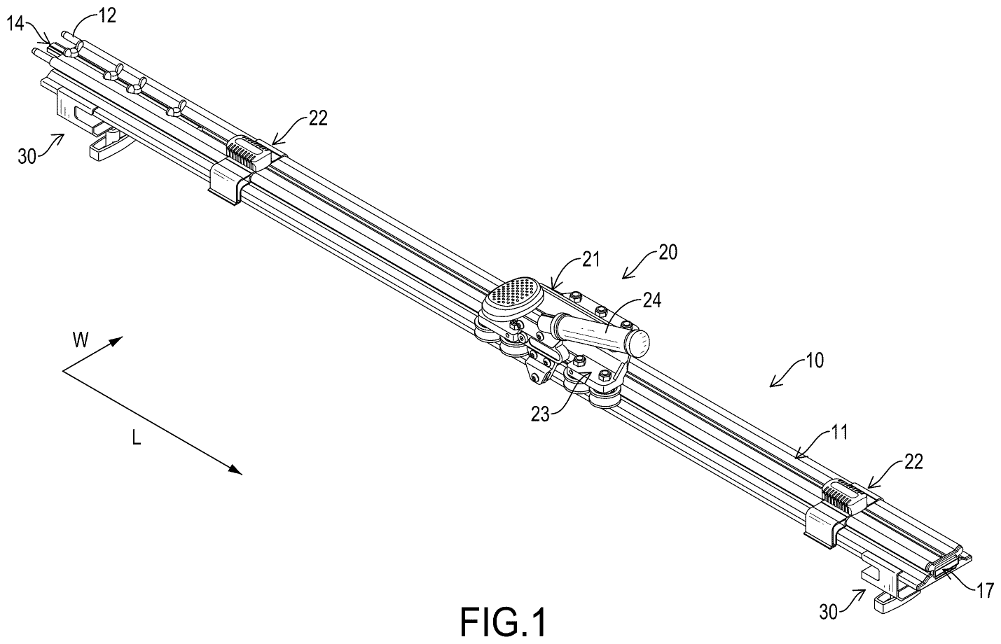

With reference to FIGS. 1 to 3, a cutting machine for sintered stones in accordance with the present invention has a track base 10, a cutting device 20, and two clamping devices 30.

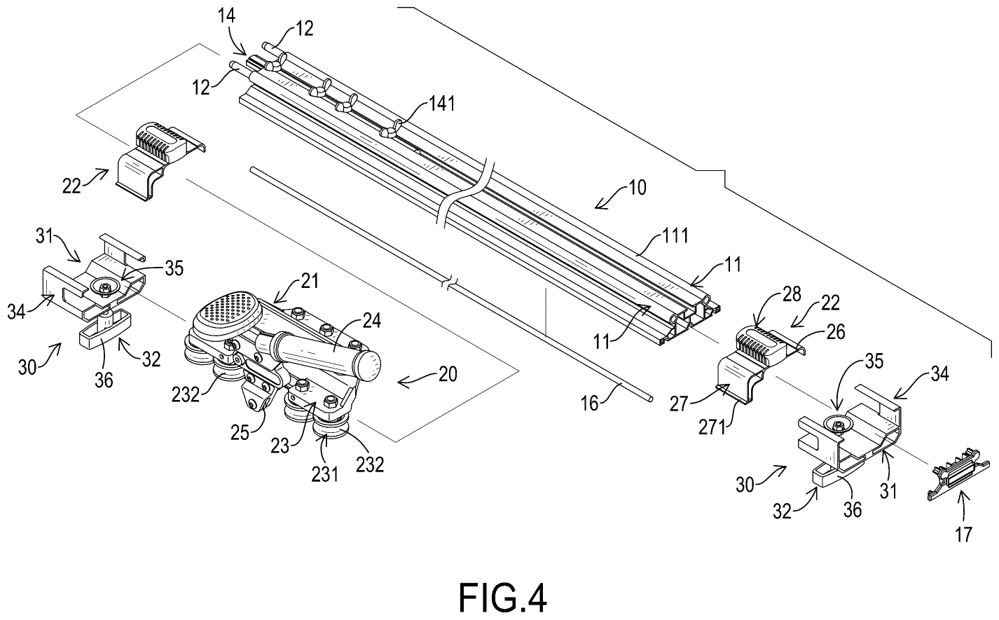

With reference to FIGS. 4 to 6, the track base 10 is elongated, may be made of aluminum extrusion metal processing, and has two engaging portions 11 disposed on a top of the track base 10 at a spaced interval. Each one of the two engaging portions 11 extends along a length direction L of the track base 10, is a hollow structure, and has an engaging annular face 111 and two openings 112. The engaging annular face 111 is formed on an external surface of the engaging portion 11, and the two openings 112 are respectively formed on two ends of the engaging portion 11. The track base 10 has an extended connecting rod 12 mounted in each one of the two engaging portions 11 and extended out of one of the two openings 112 of the corresponding engaging portion 11. Then the track base 10 can be connected to another track base 10 of the same structure via the two extended connecting rods 12, thereby increasing the overall length and being suitable for the processed sintered stones of different sizes.

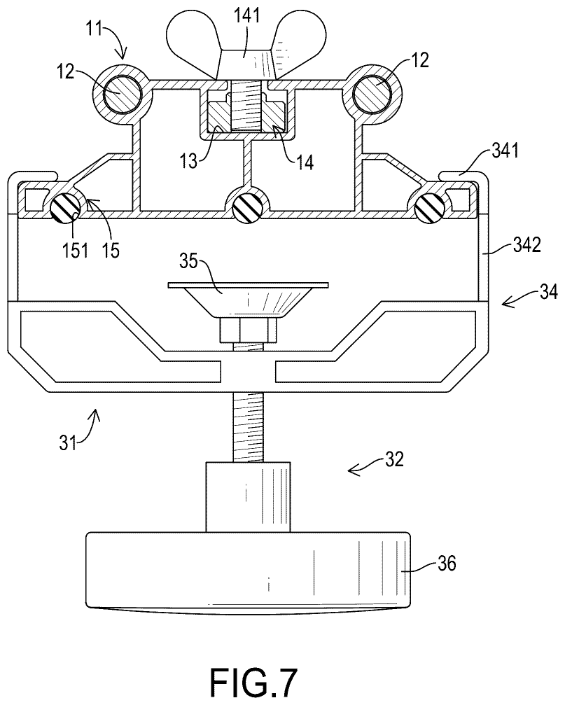

In addition, with reference to FIGS. 4 and 7, the track base 10 has a track groove 13 and an extended rail 14. The track groove 13 is formed in the top of the track base 10 between the two engaging portions 11 and extended along the length direction L of the track base 10. The extended rail 14 is mounted in the track groove 13 and has an end extended out of the track groove 13. Preferably, the extended rail 14 is disposed between two adjacent track bases 10 and has multiple fasteners 141 abutted against the two adjacent track bases 10 to connect the two adjacent track bases 10 with each other.

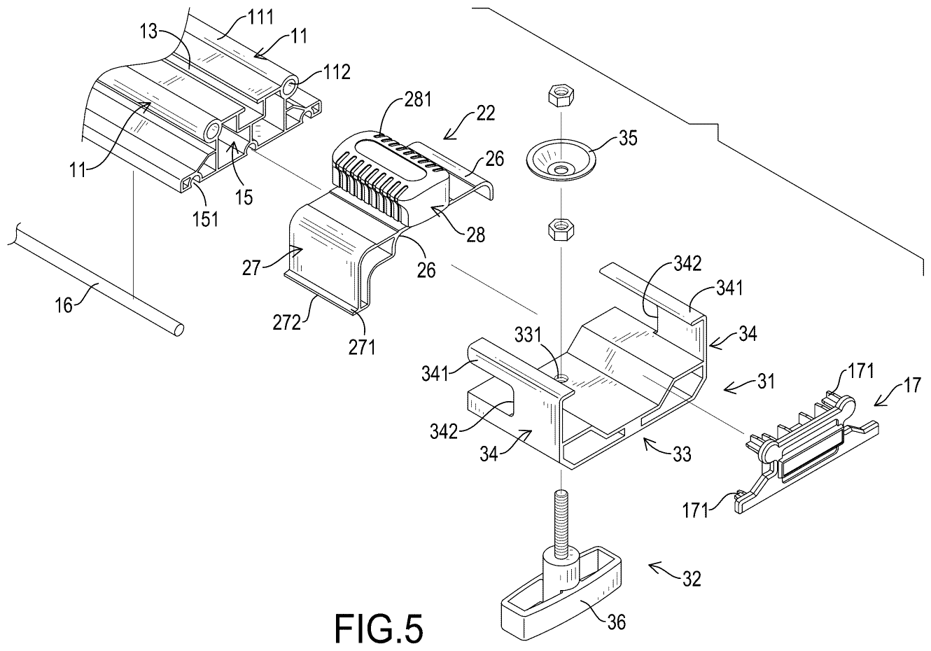

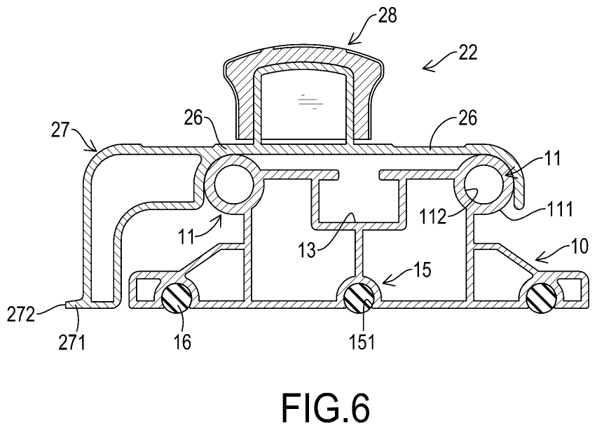

With reference to FIGS. 5 and 6, the track base 10 has at least one connecting portion 15 disposed on a bottom of the track base 10 along the length direction L of the track base 10. Each one of the at least one connecting portion 15 has a gap 151 formed through a bottom side thereof. Preferably, the track base 10 has multiple said connecting portions 15 disposed on the bottom of the track base 10 at spaced intervals. Furthermore, the track base 10 has multiple anti-slip strips 16 respectively mounted in the multiple connecting portions 15. Each one of the multiple anti-slip strips 16 is elastic, is deformed in shape by an external force, and has a portion extended to the outside of the track base 10 via the gap 151 of the corresponding connecting portion 15.

Additionally, with reference to FIGS. 4 and 5, the track base 10 has at least one end cover 17 connected to one of two ends of the track base 10 to close ends of the two engaging portions 11, the track groove 13, and the connecting portions 15 to prevent the extended connecting rods 12, the extended rail 14, and the anti-slip strips 16 from separating from the track base 10 via the corresponding ends of the engaging portion 11, the track groove 13, and the connecting portions 15. Furthermore, each one of the at least one end cover 17 has multiple sealing elements 171 formed on and protruded from an inner side of the end cover 17 and respectively mounted in the corresponding ends of the engaging portion 11, the track groove 13, and the connecting portions 15. In addition, each one of the multiple sealing elements 171 can be of a cylindrical, cross-column or U-shaped structure, which is not limited here. Preferably, the track base 10 has two said end covers 17 respectively disposed on the two ends of the track base 10.

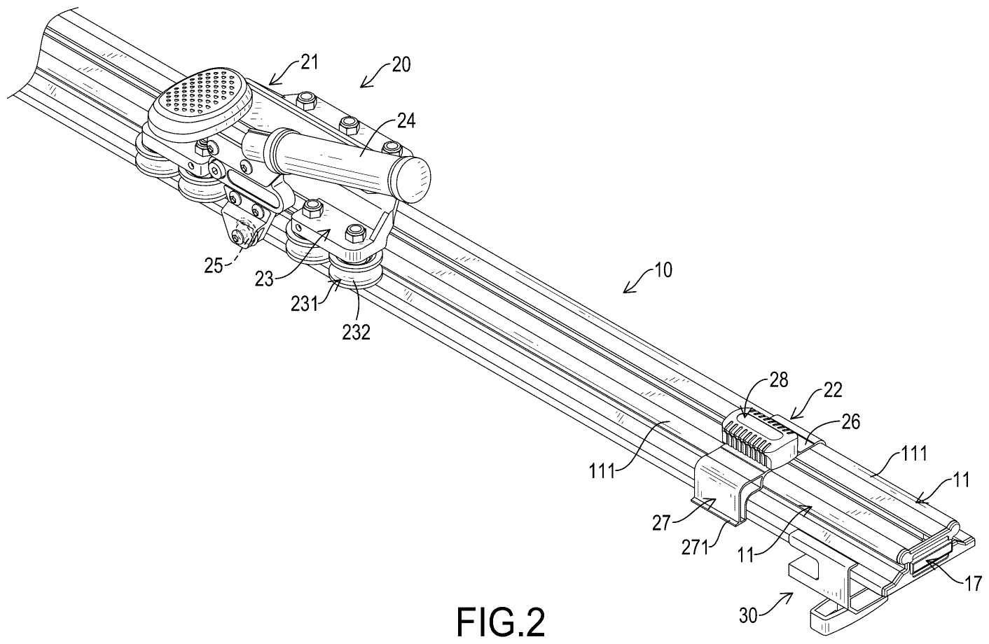

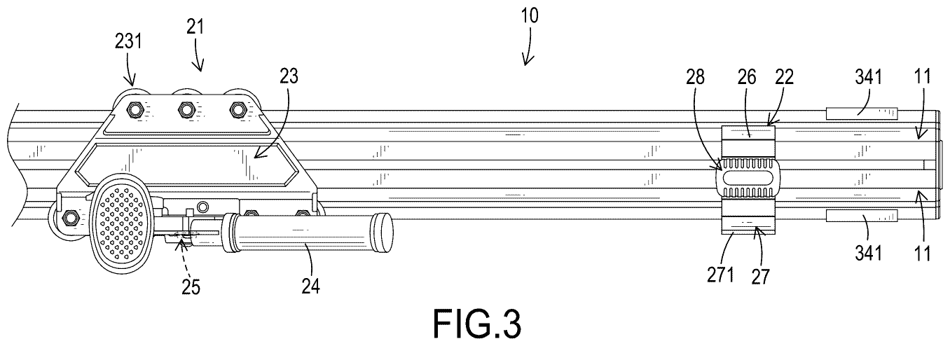

With reference to FIGS. 2 to 4, the cutting device 20 is connected to the track base 10 and has a cutter 21 and two measuring seats 22. The cutter 21 is movably connected to the track base 10 and has a sliding mount 23, an operating shaft 24, and a cutting wheel 25. The sliding mount 23 is movably connected to the track base 10 and has multiple pulleys 231. The multiple pulleys 231 are disposed on a bottom of the sliding mount 23 at two sides of the sliding mount 23. Wherein, the pulleys 231 on the two sides of the sliding mount 23 are same or different, which is not limited here. Furthermore, the pulleys 231 on one of the two sides of the sliding mount 23 are rotatably connected to one of the two engaging portions 11, and the pulleys 231 on the other one of the two sides of the sliding mount 23 are rotatably connected to the other one of the two engaging portions 11. Then the sliding mount 23 is movably disposed on the track base 10 by the multiple pulleys 231 connected to the two engaging portions 11. In addition, each one of the multiple pulleys 231 has an arc face 232 annularly formed on an external surface of the pulley 231 and engaging with the engaging annular face 111 of the corresponding engaging portion 11 to enable the pulley 231 to rotate on the corresponding engaging portion 11. With reference to FIGS. 2 and 3, the operating shaft 24 is swingably connected to the sliding mount 23 and is located at one of the two sides of the sliding mount 23. Preferably, the operating shaft 24 is disposed obliquely on the corresponding side of the sliding mount 23. The cutting wheel 25 is rotatably disposed below the operating shaft 24 at one of the two sides of the track base 10.

With reference to FIGS. 4 to 6, the two measuring seats 22 are movably disposed on the track base 10 respectively at two sides of the cutter 21. Preferably, the two measuring seats 22 are respectively disposed adjacent the two ends of the track base 10, and each of the two measuring seats 22 has two engaging arms 26, a positioning arm 27, and a pushing stem 28. The two engaging arms 26 are connected to each other, extended in opposite directions, and are respectively connected to the two engaging portions 11 of the track base 10 to dispose the measuring seat 22 on the track base 10. The positioning arm 27 is connected to one of the two engaging arms 26, and extends outwardly and downwardly adjacent to the bottom of the track base 10.

The positioning arm 27 and the cutting wheel 25 are located on the same side of the track base 10. The positioning arm 27 has a reference board 271 transversally formed on a free end of the positioning arm 27. Furthermore, the reference board 271 extends along a width direction W of the track base 10 and has an external side face 272. With reference to FIGS. 2 and 3, an imaginary extension line of the external side face 272 of the reference board 271 is in a straight line with a cutting edge of the cutting wheel 25. That is, a cutting line formed by the cutting edge of the cutting wheel 25 is located on the same straight line as the external side face 272 of the reference board 271. The pushing stem 28 is disposed on a top of the measuring seat 22 between the two engaging arms 26, and this enables users to move the measuring seat 22 relative to the track base 10 by pushing the pushing stem 28. Preferably, the pushing stem 28 has multiple notches 281 formed on an outer side of the pushing stem 28 to increase contact area and friction between the user's hand and the pushing stem 28, allowing the user to push the measuring seat 22 easily and conveniently.

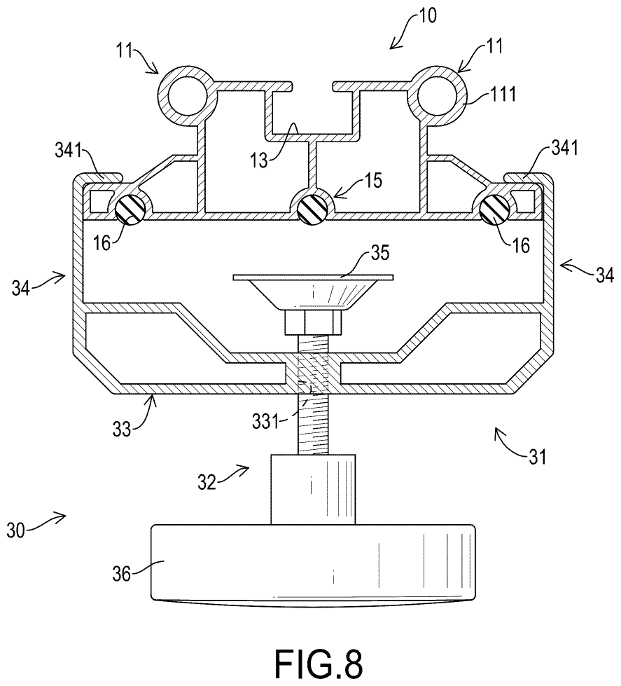

With reference to FIGS. 1, 2, 4, and 5, the two clamping devices 30 are connected to the track base 10, are disposed on the bottom of the track base 10, and are respectively located adjacent to the two ends of the track base 10. Each one of the two clamping devices 30 has a clamping mount 31 and a pressing rod 32. With reference to FIGS. 5 and 8, the clamping mount 31 has a base portion 33 and two clamping arms 34. The base portion 33 has a connecting hole 331 longitudinally formed through the base portion 33 to face the bottom of the track base 10.

The two clamping arms 34 are formed on and protruded upwardly from a top of the base portion 33, are respectively located at two sides of the base portion 33, and are respectively connected to the two sides of the track base 10. Each one of the two clamping arms 34 has a hook portion 341 and an avoidance slot 342. The hook portion 341 is formed on a free end of the clamping arm 34 away from the base portion 33 and engages with one of the two sides of the track base 10. Then the clamping mount 31 is connected to the track base 10 by the hook portions 341 of the two clamping arms 34 respectively engaging with the two sides of the track base 10. The avoidance slot 342 is formed in a side of the clamping arm 34 facing the track base 10 between the hook portion 341 and the base portion 33.

The pressing rod 32 is rotatably connected to the base portion 33 of the clamping mount 31 to move toward or away from the bottom of the track base 10, and has a top end, a bottom end, a pushing disk 35, and a rotating handle 36. The top end of the pressing rod 32 extends above the top of the base portion 33 between the two clamping arms 34 via the connecting hole 331, and the pushing disk 35 is disposed on the top end of the pressing rod 32. The bottom end of the pressing rod 32 is disposed below the base portion 33, and the rotating handle 36 is disposed on the bottom end of the pressing rod 32. When the rotating handle 36 is rotated by a user, the pressing rod 32 is rotated relative to the base portion 33, and a distance between the pushing disk 35 and the bottom of the track base 10 can be changed and adjusted.

Additionally, the connecting hole 331 has an inner thread, and the pressing rod 32 has an outer thread formed on an external surface of the pressing rod 32 to screw with the inner thread of the connecting hole 331. Furthermore, the measuring seat 22 and each clamping mount 31 are provided in a hollow manner, which not only allows the positioning arm 27 of the measuring seat 22 and the base portion 33 of each clamping mount 31 to be elastic, but also reduces cost of manufacture, and can greatly reduce the overall weight of the cutting machine for sintered stones of the present invention, allowing users to transport and store it conveniently.

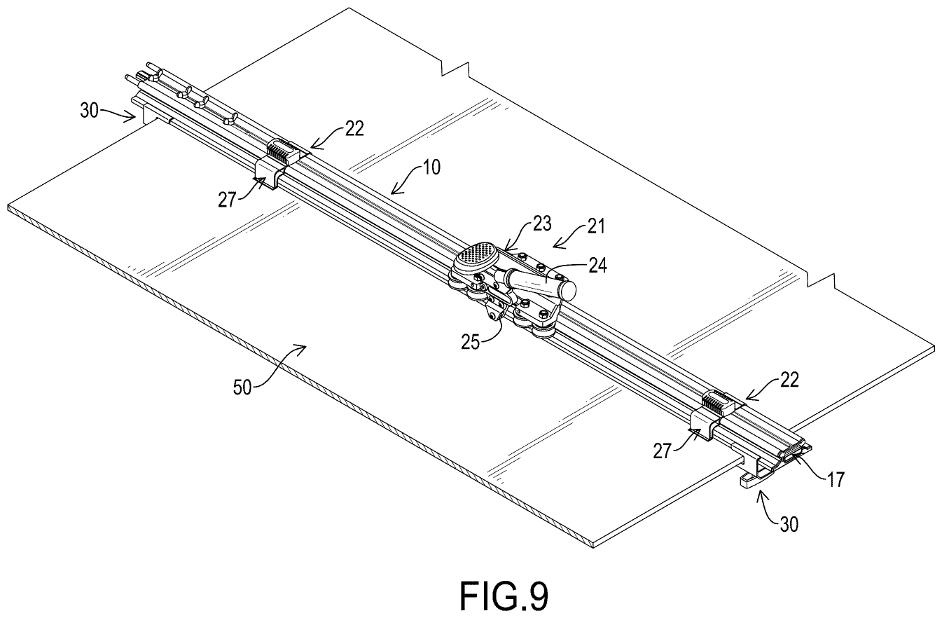

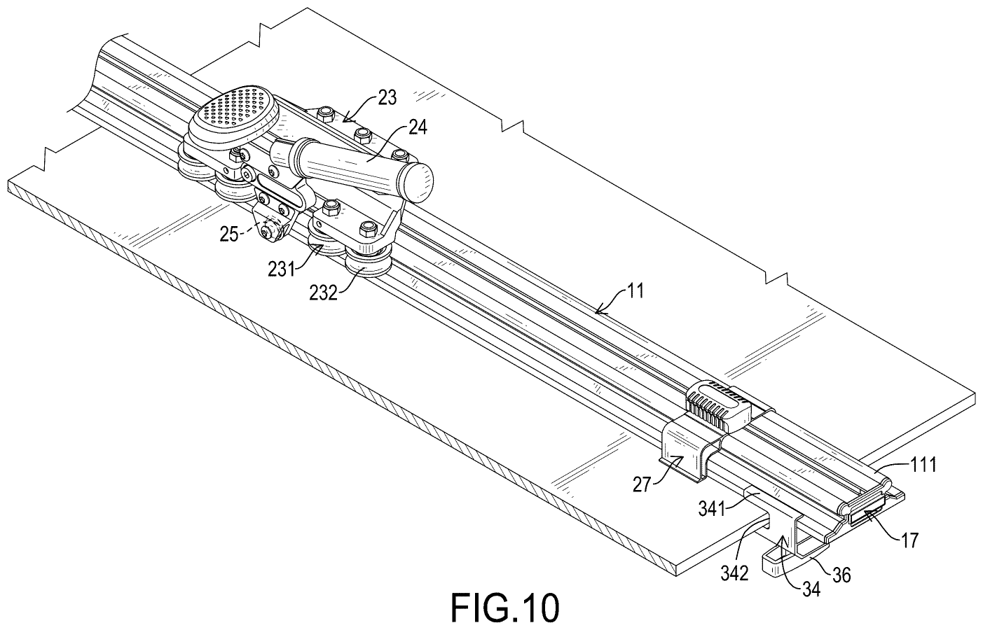

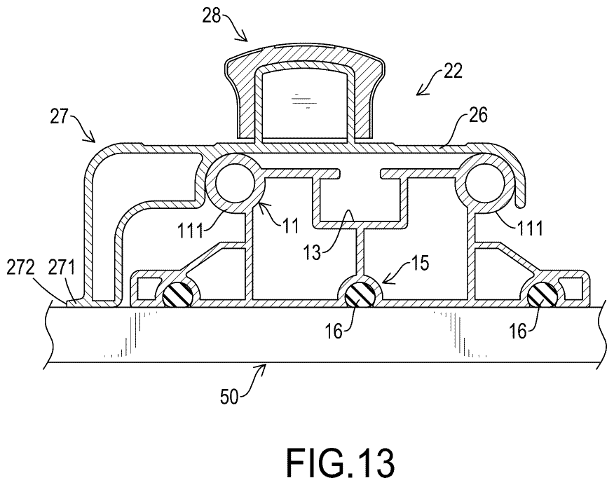

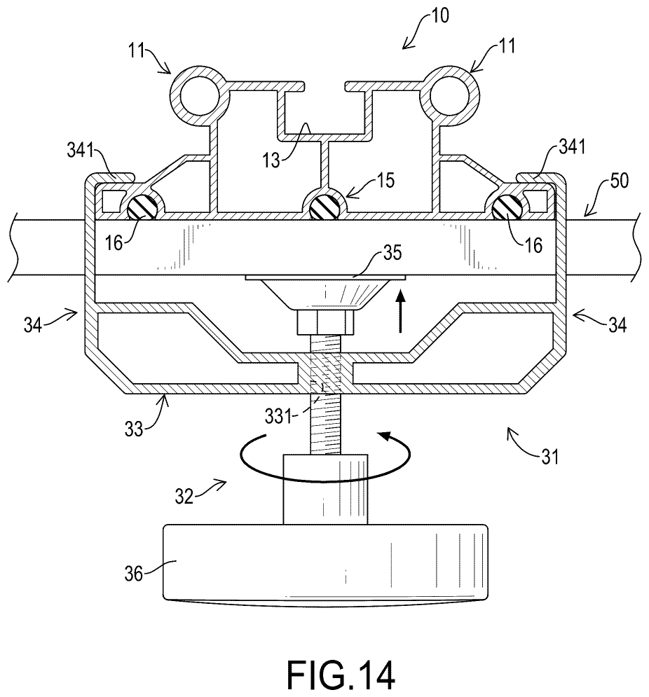

With reference to FIGS. 9 and 10, when the cutting machine for sintered stones of the present invention is in use, firstly, the track base 10 is disposed on a processed sintered stone 50, and the anti-slip strips 16 on the bottom of the track base 10 are deformed and abutted against a top face of the processed sintered stone 50 to enable the track base 10 to firmly and stably abut on the top face of the processed sintered stone 50 as shown in FIG. 13. With reference to FIGS. 10 and 14, then the avoidance slot 342 of the clamping arm 34 of each clamping mount 31 enables the corresponding clamping arm 34 to mount on the processed sintered stone 50, and the processed sintered stone 50 is placed between the track base 10 and the pushing disk 35 of the pressing rod 32 of each clamping device 30.

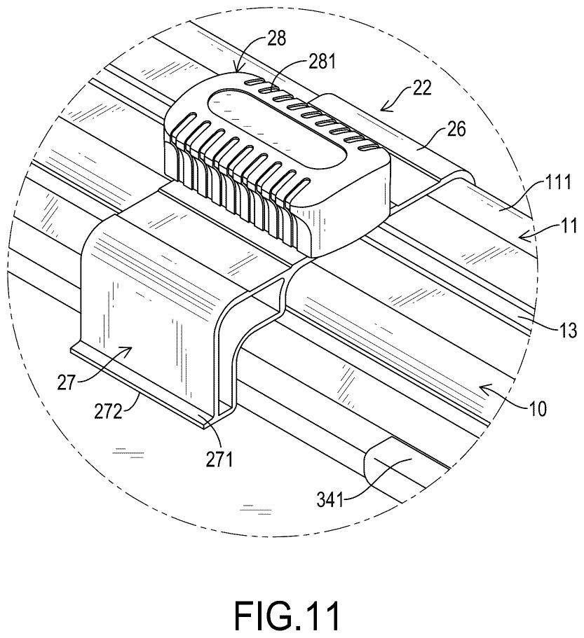

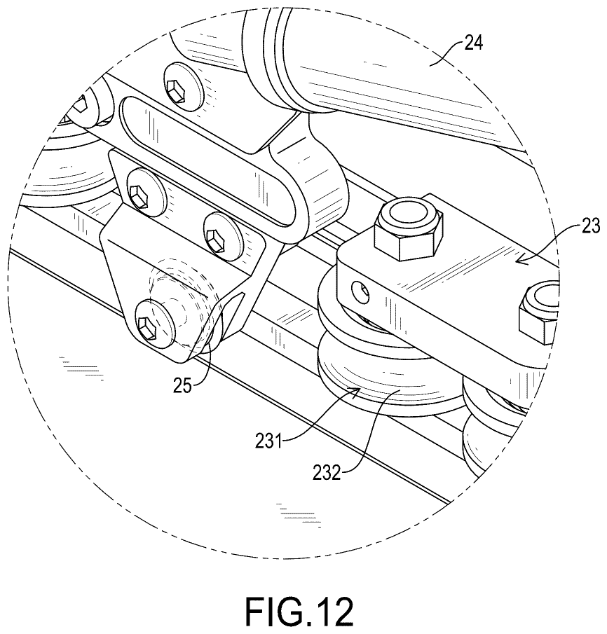

At this time, with reference to FIGS. 11 and 12, since the external side face 272 of the reference board 271 of the positioning arm 27 of each of the two measuring seats 22 and the cutting edge of the cutting wheel 25 are located on the same straight line, when a user wants to measure the position for cutting size of the processed sintered stone 50, the user no longer needs to insert fingers to the cutting edge of the cutting wheel 25, but can use the external side face 272 of the reference board 271 of each measuring seat 22 as the position for cutting size of the processed sintered stone 50, and this not only can measure the position for cutting size of the processed sintered stone 50 conveniently and accurately, but also can avoid injuries caused by contact with the cutting edge of the cutting wheel 25, and greatly improve the safety of use.

Furthermore, after confirming the position for cutting size of the processed sintered board 50 by measuring the external side face 272 of the reference board 271 of each of the two measuring seats 22, with reference to FIG. 14, the user can rotate the rotating handle 36 of the pressing rod 32 of each clamping device 30 to move the pressing rod 32 to move toward the track base 10 and to enable the pushing disk 35 to abut against the bottom face of the processed sintered stone 50. Then the track base 10 can be held securely and firmly on the processed sintered stone 50 by the pushing disk 35 of each clamping device 30 upwardly pushing the bottom face of the processed sintered stone 50 and the two clamping arms 34 of each clamping device 30 downwardly clamping the track base 10.

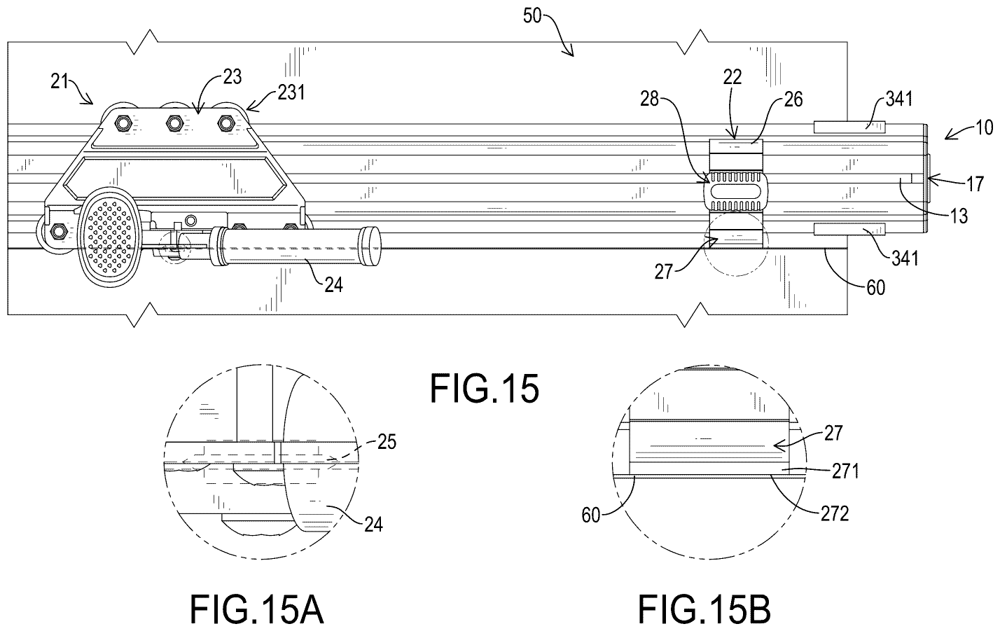

At this time, with reference to FIG. 15, the user can hold and swing the operating shaft 24 downwardly relative to the sliding mount 23 to move the cutting wheel 25 in contact with the top face of the processed sintered stone 50. Since the sliding mount 23 can be moved along the track base 10 via the multiple pulleys 231 rotating relative to the two engaging portions 11, the user can move the sliding mount 23 moving along the track base 10 by the operating shaft 24. Then, with reference to FIGS. 15 and 15A, a cutting line 60 is formed on the top face of the processed sintered stone 50 by the cutting wheel 25. Furthermore, with reference to FIG. 15B, the cutting line 60 is aligned with the external side face 272 of the reference board 271 of each one of the two measuring seats 22. After the above operations, the processed sintered stone 50 can be cut to an accurate size.

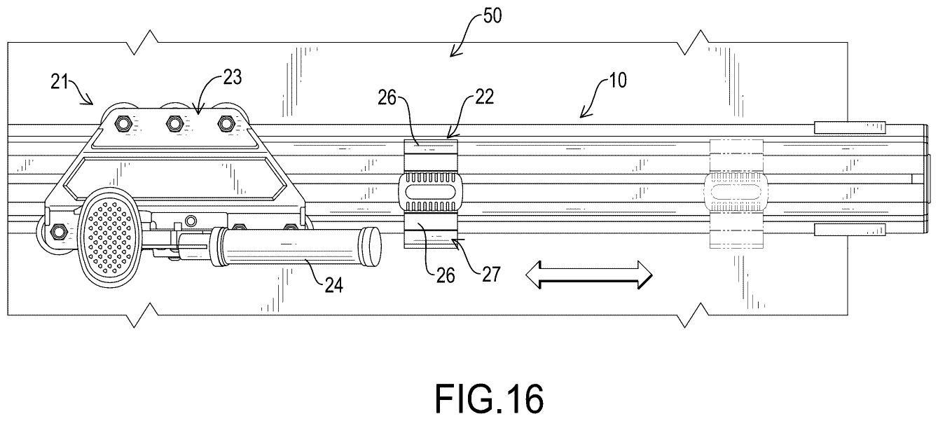

Additionally, with reference to FIGS. 13 and 16, each one of the two measuring seats 22 of the cutting device 20 is disposed on the track base 10 by the two engaging arms 26 respectively engaging with the two engaging portions 11. Then the user can adjust the position of each one of the two measuring seats 22 relative to the track base 10 by pushing the pushing stem 28, and this allows the user to flexibly and conveniently measure the cutting size of the processed sintered stone 50 via the two measuring seats 22.

According to the above-mentioned structural relationships and features of the cutting machine for sintered stones of the present invention, in use, the user can measure the cutting size of the processed sintered stone 50 via the external side face 272 of the reference board 271 of each one of the two measuring seats 22 since the external side face 272 of the reference board 271 of each one of the two measuring seats 22 is aligned with the cutting edge of the cutting wheel 25, and does not have to measure the cutting edge of the cutting wheel 25, which not only allows for convenient and accurate measurement of the cutting size, but also prevents the user from being injured due to contact with the cutting edge of the cutting wheel 25, greatly improving the safety of use.

Furthermore, the track base 10 can be firmly clamped and disposed on the processed sintered stone 50 by the clamping arms 34 and the pressing rods 32 of the two clamping devices 30. The subsequent cutting process will not affect the accuracy of cutting due to the offset of the track base 10. Additionally, the anti-slip strips 16 located on the bottom of the track base 10 can allow the track base 10 to more firmly abut against the top face of the processed sintered stone 50. Therefore, the present invention provides a cutting machine for sintered stones that is convenient for measurement, safe to use, securely clamped, and accurate for cutting.

Even though numerous characteristics and advantages of the present invention have been set forth in the foregoing description, together with details of the structure and features of the utility model, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A cutting machine for sintered stones comprising:
a track base having
a bottom;
a length direction;
two sides;
at least one connecting portion disposed on the bottom of the track base along the length direction of the track base, and each one of the at least one connecting portion having
a gap formed through a bottom side thereof; and
an anti-slip strip mounted in the connecting portion and having a portion extended to the outside of the track base via the gap; and
a cutting device connected to the track base and having
a cutter disposed on the track base and having a cutting wheel located on one of the two sides of the track base; and
two measuring seats movably disposed on the track base respectively at two sides of the cutter, and each one of the two measuring seats having
a positioning arm located on the side of the track base same as the cutting wheel and having
a reference board formed on a free end of the positioning arm and having an external side face; and
two clamping devices connected to the track base, disposed on the bottom of the track base, respectively located adjacent to two ends of the track base, and each one of the two clamping devices having
a clamping mount engaging with the two sides of the track base; and
a pressing rod rotatably connected to the clamping mount to move toward or away from the bottom of the track base;
wherein an imaginary extension line of the external side face of the reference board of each one of the two measuring seats is in a straight line with a cutting edge of the cutting wheel.

2. The cutting machine for sintered stones as claimed in claim 1, wherein the track base has multiple said connecting portions disposed on the bottom of the track base at spaced intervals.

3. The cutting machine for sintered stones as claimed in claim 1, wherein
the track base has
two engaging portions disposed on a top of the track base at a spaced interval, and each one of the two engaging portions extended along the length direction of the track base; and
the cutter has
a sliding mount movably connected to the track base and having
multiple pulleys disposed on a bottom of the sliding mount at two sides of the sliding mount, the pulleys on one of the two sides of the sliding mount rotatably connected to one of the two engaging portions, and the pulleys on the other one of the two sides of the sliding mount rotatably connected to the other one of the two engaging portions.

4. The cutting machine for sintered stones as claimed in claim 2, wherein
the track base has
two engaging portions disposed on a top of the track base at a spaced interval, and each one of the two engaging portions extended along the length direction of the track base; and
the cutter has
a sliding mount movably connected to the track base and having
multiple pulleys disposed on a bottom of the sliding mount at two sides of the sliding mount, the pulleys on one of the two sides of the sliding mount rotatably connected to one of the two engaging portions, and the pulleys on the other one of the two sides of the sliding mount rotatably connected to the other one of the two engaging portions.

5. The cutting machine for sintered stones as claimed in claim 3, wherein
each one of the two engaging portions has an engaging annular face formed on an external surface of the engaging portion; and
each one of the multiple pulleys has an arc face annularly formed on an external surface of the pulley and engaging with the engaging annular face of a corresponding one of the engaging portions to enable the pulley to rotate on the corresponding engaging portion.

6. The cutting machine for sintered stones as claimed in claim 4, wherein
each one of the two engaging portions has an engaging annular face formed on an external surface of the engaging portion; and
each one of the multiple pulleys has an arc face annularly formed on an external surface of the pulley and engaging with the engaging annular face of a corresponding one of the engaging portions to enable the pulley to rotate on the corresponding engaging portion.

7. The cutting machine for sintered stones as claimed in claim 3, wherein
each one of the two engaging portions is a hollow structure and has two openings respectively formed on two ends of the engaging portion; and
the track base has
an extended connecting rod mounted in each one of the two engaging portions and extended out of one of the two openings of the corresponding engaging portion;
a track groove formed in the top of the track base between the two engaging portions, and extended along the length direction of the track base; and
an extended rail mounted in the track groove.

8. The cutting machine for sintered stones as claimed in claim 4, wherein
each one of the two engaging portions is a hollow structure and has two openings respectively formed on two ends of the engaging portion; and
the track base has
an extended connecting rod mounted in each one of the two engaging portions and extended out of one of the two openings of the corresponding engaging portion;
a track groove formed in the top of the track base between the 20 two engaging portions, and extended along the length direction of the track base; and
an extended rail mounted in the track groove.

9. The cutting machine for sintered stones as claimed in claim 3, wherein
each one of the two measuring seats has
two engaging arms connected to each other, extended in opposite directions, and respectively connected to the two engaging portions of the track base; and
a pushing stem disposed on a top of the measuring seat between the two engaging arms; and
the positioning arm of each one of the two measuring seats is connected to one of the two engaging arms of the corresponding measuring seat, and extends outwardly and downwardly adjacent to the bottom of the track base.

10. The cutting machine for sintered stones as claimed in claim 4, wherein
each one of the two measuring seats has
two engaging arms connected to each other, extended in opposite directions, and respectively connected to the two engaging portions of the track base; and
a pushing stem disposed on a top of the measuring seat between the two engaging arms; and
the positioning arm of each one of the two measuring seats is connected to one of the two engaging arms of the corresponding measuring seat, and extends outwardly and downwardly adjacent to the bottom of the track base.

11. The cutting machine for sintered stones as claimed in claim 7,
wherein the clamping mount of each one of the two clamping devices has a base portion; and
two clamping arms formed on and protruded upwardly from a top of the base portion, respectively located at two sides of the base portion, respectively connected to the two sides of the track base, and each one of the two clamping arms having
a hook portion formed on a free end of the clamping arm away from the base portion and engaging with one of the two sides of the track base; and
an avoidance slot formed in a side of the clamping arm facing the track base between the hook portion and the base portion.

12. The cutting machine for sintered stones as claimed in claim 8,
wherein the clamping mount of each one of the two clamping devices has a base portion; and
two clamping arms formed on and protruded upwardly from a top of the base portion, respectively located at two sides of the base portion, respectively connected to the two sides of the track base, and each one of the two clamping arms having
a hook portion formed on a free end of the clamping arm away from the base portion and engaging with one of the two sides of the track base; and
an avoidance slot formed in a side of the clamping arm facing the track base between the hook portion and the base portion.

13. The cutting machine for sintered stones as claimed in claim 11, wherein
the base portion of the clamping mount of each one of the two clamping devices has a connecting hole formed through the base portion;
the pressing rod of each one of the two clamping devices is rotatably connected to the base portion of the clamping mount of the corresponding clamping device and has
a top end extended above the top of the base portion between the two clamping arms via the connecting hole;
a bottom end disposed below the base portion;
a pushing disk disposed on the top end of the pressing rod; and
a rotating handle disposed on the bottom end of the pressing rod.

14. The cutting machine for sintered stones as claimed in claim 12, wherein
the base portion of the clamping mount of each one of the two clamping devices has a connecting hole formed through the base portion;
the pressing rod of each one of the two clamping devices is rotatably connected to the base portion of the clamping mount of the corresponding clamping device and has
a top end extended above the top of the base portion between the two clamping arms via the connecting hole;
a bottom end disposed below the base portion;
a pushing disk disposed on the top end of the pressing rod; and
a rotating handle disposed on the bottom end of the pressing rod.

15. The cutting machine for sintered stones as claimed in claim 7, wherein
the track base has at least one end cover connected to one of the two ends of the track base to close ends of the two engaging portions, the track groove, and the connecting portions; and
each one of the at least one end cover has multiple sealing elements formed on and protruded from an inner side of the end cover and respectively mounted in the corresponding ends of the engaging portion, the track groove, and the connecting portions.

16. The cutting machine for sintered stones as claimed in claim 8, wherein
the track base has at least one end cover connected to one of the two ends of the track base to close ends of the two engaging portions, the track groove, and the connecting portions; and
each one of the at least one end cover has multiple sealing elements formed on and protruded from an inner side of the end cover and respectively mounted in the corresponding ends of the engaging portion, the track groove, and the connecting portions.

17. The cutting machine for sintered stones as claimed in claim 13, wherein
the track base has at least one end cover connected to one of the two ends of the track base to close ends of the two engaging portions, the track groove, and the connecting portions; and
each one of the at least one end cover has multiple sealing elements formed on and protruded from an inner side of the end cover and respectively mounted in the corresponding ends of the engaging portion, the track groove, and the connecting portions.

18. The cutting machine for sintered stones as claimed in claim 14, wherein
the track base has at least one end cover connected to one of the two ends of the track base to close ends of the two engaging portions, the track groove, and the connecting portions; and
each one of the at least one end cover has multiple sealing elements formed on and protruded from an inner side of the end cover and respectively mounted in the corresponding ends of the engaging portion, the track groove, and the connecting portions.
